(19) United States
(12) Patent Application Publication
(10) Pub. No.: US 2025/0312699 A1
(43) Pub. Date: Oct. 9, 2025

(54) DATA PROCESSING APPARATUS AND METHOD

(71) Applicant: Sony Interactive Entertainment Inc., Tokyo (JP)

(72) Inventors: Pierluigi Vito Amadori, London (GB); Timothy Edward Bradley, London (GB); Guy Moss, London (GB); Ryan John Spick, London (GB); Ayush Raina, San Mateo, CA (US)

(73) Assignee: Sony Interactive Entertainment Inc., Tokyo (JP)

(21) Appl. No.: 19/091,051

(22) Filed: Mar. 26, 2025

(30) Foreign Application Priority Data
Apr. 4, 2024 (GB) 2404814.2

(51) Int. Cl. A63F 13/67

(52) U.S. Cl. CPC A63F 13/67

(57) ABSTRACT

A data processing apparatus comprising circuitry configured to: obtain gameplay data indicating in-game behaviour of a human video game player; configure, using the obtained gameplay data, an artificial intelligence, AI, agent representing the human video game player; execute one or more AI agent video game sessions including the AI agent and obtain AI agent performance data indicating in-game performance of the AI agent during the one or more AI agent video game sessions; and perform matchmaking of the human video game player with another human video game player based on the obtained AI agent performance data.

### CROSS REFERENCE TO RELATED APPLICATIONS

The present application claims priority to United Kingdom (GB) Application No. 2404814.2 filed Apr. 4,2024, the contents of which is incorporated by reference herein in its entirety for all purposes.

### BACKGROUND

### Field of the Disclosure

This disclosure relates to a data processing apparatus and method.

### Description of the Related Art

The “background” description provided is for the purpose of generally presenting the context of the disclosure. Work of the presently named inventors, to the extent it is described in the background section, as well as aspects of the description which may not otherwise qualify as prior art at the time of filing, are neither expressly or impliedly admitted as prior art against the present disclosure.

Matchmaking in multiplayer video games refers to the matching of video game players of similar ability to play against each other. It is particularly applicable to online multiplayer video games, where each video game player remotely plays against other player(s) they may never have met before (either online or in real life). If player matching does not occur effectively (and therefore one player is significantly better at playing the video game than the player they are matched with), this can be detrimental to the video game experience of both players. In particular, the player who is better at playing the game may not feel challenged and get bored and the player who is worse at playing the game may feel frustrated that they keep getting beaten in the game. Effective gaming matchmaking is therefore desirable in helping to provide stimulating and rewarding gameplay.

A problem, however, is that obtaining enough information about a particular player to enable effective matchmaking of that player with other players takes time. For instance, it is often necessary for such information to be collected over a certain amount of gameplay (e.g. for at least a certain number of hours of gameplay) before the information is sufficiently useful for matching. This means that, before the necessary amount of gameplay has been completed by the player, matchmaking of that player with other players may not be appropriate. Furthermore, for more occasional game players (e.g. players who only play once every few weeks or months), they may never reach the necessary amount of gameplay, meaning effective matchmaking for that player may never be realised.

There is therefore a desire to address this problem.

### SUMMARY

The present technology is defined by the claims.

### BRIEF DESCRIPTION OF THE DRAWINGS

Non-limiting embodiments and advantages of the present disclosure are explained with reference to the following detailed description taken in conjunction with the accompanying drawings, wherein:

FIG. 1 schematically shows an example entertainment system;

FIGS. 2A and 2B schematically show example components associated with the entertainment system;

FIG. 3 schematically shows an example network;

FIGS. 4A to 4C schematically show example AI agent configuration techniques;

FIGS. 5A and 5B schematically shows an example video game matchmaking technique; and

FIG. 6 shows an example method.

Like reference numerals designate identical or corresponding parts throughout the drawings.

### DETAILED DESCRIPTION OF THE EMBODIMENTS

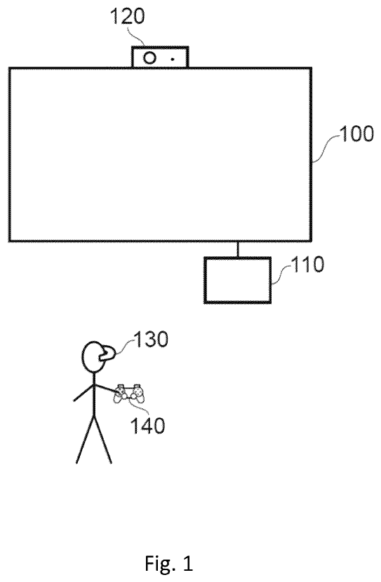

FIG. 1 schematically illustrates an entertainment system suitable for implementing one or more of the embodiments of the present disclosure. Any suitable combination of devices and peripherals may be used to implement embodiments of the present disclosure, rather than being limited only to the configuration shown.

A display device 100 (e.g. a television or monitor), associated with a games console 110, is used to display content to one or more users. A user is someone who interacts with the displayed content, such as a player of a game, or, at least, someone who views the displayed content. A user who views the displayed content without interacting with it may be referred to as a viewer. This content may be a video game, for example, or any other content such as a movie or any other video content. The games console 110 is an example of a content providing device or entertainment device; alternative, or additional, devices may include computers, mobile phones, set-top boxes, and physical media playback devices, for example. In some embodiments the content may be obtained by the display device itself-for instance, via a network connection or a local hard drive.

One or more video and/or audio capture devices (such as the integrated camera and microphone 120) may be provided to capture images and/or audio in the environment of the display device. While shown as a separate unit in FIG. 1, it is considered that such devices may be integrated within one or more other units (such as the display device 100 or the games console 110 in FIG. 1).

In some implementations, an additional or alternative display device such as a head-mountable display (HMD) 130 may be provided. Such a display can be worn on the head of a user, and is operable to provide augmented reality or virtual reality content to a user via a near-eye display screen. A user may be further provided with a video game controller 140 which enables the user to interact with the games console 110. This may be through the provision of buttons, motion sensors, cameras, microphones, and/or any other suitable method of detecting an input from or action by a user.

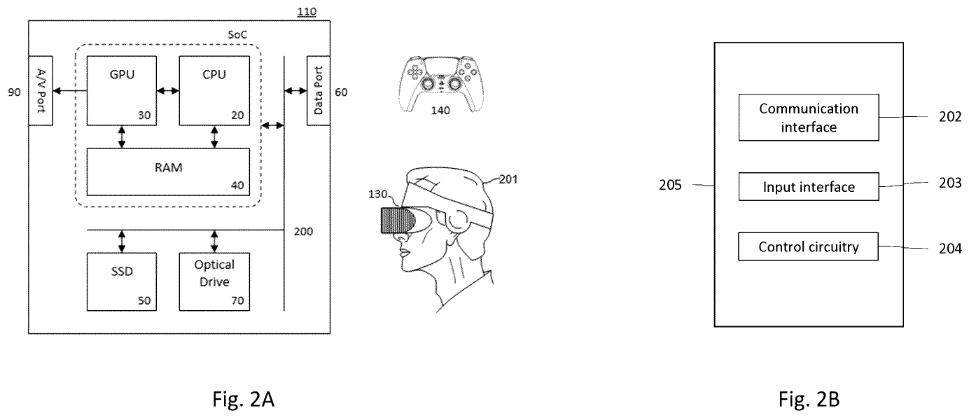

FIG. 2A shows an example of the games console 110. The games console 110 is an example of a data processing apparatus.

The games console 110 comprises a central processing unit or CPU 20. This may be a single or multi core processor, for example comprising eight cores. The games console also comprises a graphical processing unit or GPU 30. The GPU can be physically separate to the CPU, or integrated with the CPU as a system on a chip (SoC).

The games console also comprises random access memory, RAM 40, and may either have separate RAM for each of the CPU and GPU, or shared RAM. The or each RAM can be physically separate, or integrated as part of an SoC. Further storage is provided by a disk 50, either as an external or internal hard drive, or as an external solid state drive (SSD), or an internal SSD.

The games console may transmit or receive data via one or more data ports 60, such as a universal serial bus (USB) port, Ethernet® port, WiFi® port, Bluetooth® port or similar, as appropriate. It may also optionally receive data via an optical drive 70.

Interaction with the games console is typically provided using one or more instances of the controller 140. In an example, communication between each controller 140 and the games console 110 occurs via the data port(s) 60.

Audio/visual (A/V) outputs from the games console are typically provided through one or more A/V ports 90, or through one or more of the wired or wireless data ports 60. The A/V port(s) 90 may also receive audio/visual signals output by the integrated camera and microphone 120, for example. The microphone is optional and/or may be separate to the camera. Thus, the integrated camera and microphone 120 may instead be a camera only. The camera may capture still and/or video images.

Where components are not integrated, they may be connected as appropriate either by a dedicated data link or via a bus 200.

As explained, examples of a device for displaying images output by the game console 110 are the display device 100 and the HMD 130. The HMD is worn by a user 201. In an example, communication between the display device 100 and the games console 110 occurs via the A/V port(s) 90 and communication between the HMD 130 and the games console 110 occurs via the data port(s) 60.

The controller 140 is an example of a peripheral device for allowing the games console 110 to receive input from and/or provide output to the user. Examples of other peripheral devices include wearable devices (such as smartwatches, fitness trackers and the like), microphones (for receiving speech input from the user) and headphones (for outputting audible sounds to the user).

FIG. 2B shows some example components of a peripheral device 205 for receiving input from a user. The peripheral device comprises a communication interface 202 for transmitting wireless signals to and/or receiving wireless signals from the games console 110 (e.g. via data port(s) 60) and an input interface 203 for receiving input from the user. The communication interface 202 and input interface 203 are controlled by control circuitry 204.

In an example, if the peripheral device 205 is a controller (like controller 140), the input interface 203 comprises buttons, joysticks and/or triggers or the like operable by the user. In another example, if the peripheral device 205 is a microphone, the input interface 203 comprises a transducer for detecting speech uttered by a user as an input. In another example, if the peripheral device 205 is a fitness tracker, the input interface 203 comprises a photoplethysmogram (PPG) sensor for detecting a heart rate of the user as an input. The input interface 203 may take any other suitable form depending on the type of input the peripheral device is configured to detect.

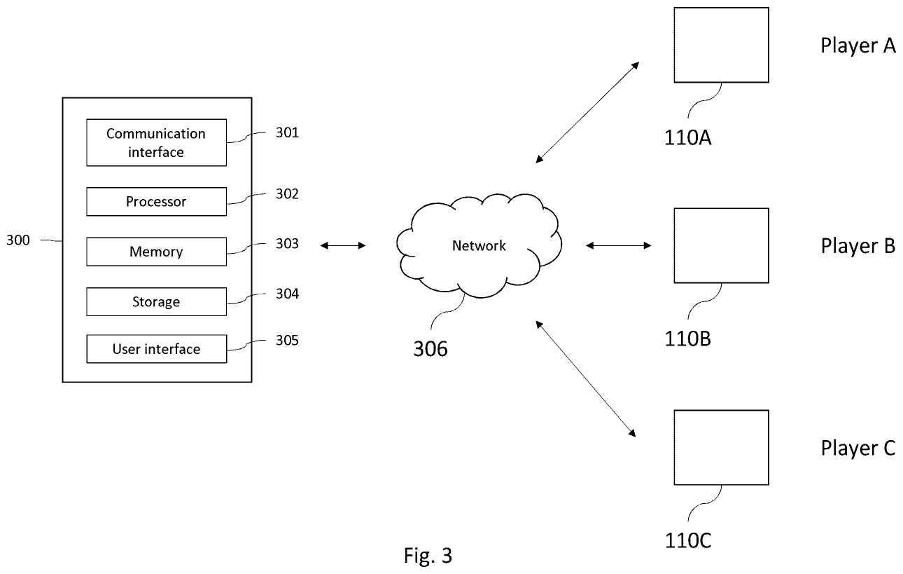

FIG. 3 shows an example of a server 300 for enabling online multiplayer gaming between a plurality of players (Players A, B and C in this example). Each of the players are located in a different geographical location and play video games via respective games consoles 110A, 110B and 110C. The server 300 and games consoles 110A, 110B and 110C form a system.

The server 300 is another example of a data processing apparatus and comprises a communication interface 301 for sending electronic information to and/or receiving electronic information from one or more other apparatuses, a processor 302 for executing electronic instructions, a memory 303 (e.g. volatile memory) for storing the electronic instructions to be executed and electronic input and output information associated with the electronic instructions, a storage medium 304 (e.g. non-volatile memory) for long term (persistent) storage of information and a user interface 305 (e.g. a touch screen, a non-touch screen, buttons, a keyboard and/or a mouse) for receiving commands from and/or outputting information to a user. Each of the communication interface 301. processor 302, memory 303, storage medium 304 and user interface 305 are implemented using appropriate circuitry, for example. The processor 302 controls the operation of each of the communication interface 301, memory 303, storage medium 304 and user interface 305. The server 300 is connected over a network 306 (e.g. the internet) to the plurality of games consoles 110A, 110B and 110C (each of which has the previously-described features of games console 110). The server 300 connects to the network 306 via the communication interface 301 and each games console 110A, 110B and 110C connects to the network 306 via its respective data port(s) 60, for example. The server 300 transmits gaming data to, receives gaming data from and routes gaming data between the games consoles 110A, 110B and 110C to enable multiplayer online gaming between the players. Although only one server 300 is shown, there may be a plurality of servers (each having a similar configuration to that of server 300).

The present technology uses inverse reinforcement learning (IRL)-based and/or reinforcement learning (RL)-based technique(s) to improve matchmaking for players in multiplayer games. In particular, it is applicable for players for which sufficient information from actual gameplay of the player is not available for effective matchmaking.

The technology allows the development of artificial intelligence (AI) agents (one agent per player) whose behaviour is tailored to correspond to that of a respective human player (e.g. mimicking characteristics of the human player such as, for instance, their reaction times, style of play and performance). The AI agents are then deployed against each other on one or more servers (e.g. server(s) 300) configured to execute gaming sessions between the AI agents. Synthetic gaming ability data for each AI agent is then extracted from the AI agent gaming sessions. The synthetic gaming ability data for an AI agent is data indicative of a gaming ability of that AI agent.

Because the AI agent has been created to have corresponding player characteristics to the human player it is associated with, the synthetic gaming ability data can be used in place of (or in addition to) actual gaming ability data of the human player. This is particularly useful if sufficient real gameplay data of the human player for generating meaningful real gaming ability data is not available (e.g. since the human player has not played the video game concerned for a sufficient amount of time).

The synthetic gaming ability data of the AI agents of two human players can thus be used to determine whether those two human players are appropriately matched in ability. In an example, the synthetic gaming ability data can take any form as long as it indicates an ability of the AI agent (and therefore of the associated human player) at playing a particular video game relative to other AI agents (and therefore relative to the other associated human players). For example, the synthetic gaming ability data may be a numerical performance score indicating gaming ability (with, for example, a higher score indicating greater gaming ability and a lower score indicating lower gaming ability). The numerical score may be determined using the known Elo or Matchmaking Rating (MMR) rating systems, for example.

In an example, a two-step approach is used. In a first step, the AI agents are configured (by appropriate training, for example) so they have corresponding player characteristics to those of their respective human players. In this way, each AI agent represents a respective human player. In a second step, gaming sessions are executed in which the trained AI agents are controlled to compete against each other to generate the synthetic gaming ability data. Each of first and second steps are executed by the server(s) 300 and/or games console(s) (e.g. games consoles 110A, 110B and 110C) connected to the server(s) 300, for example.

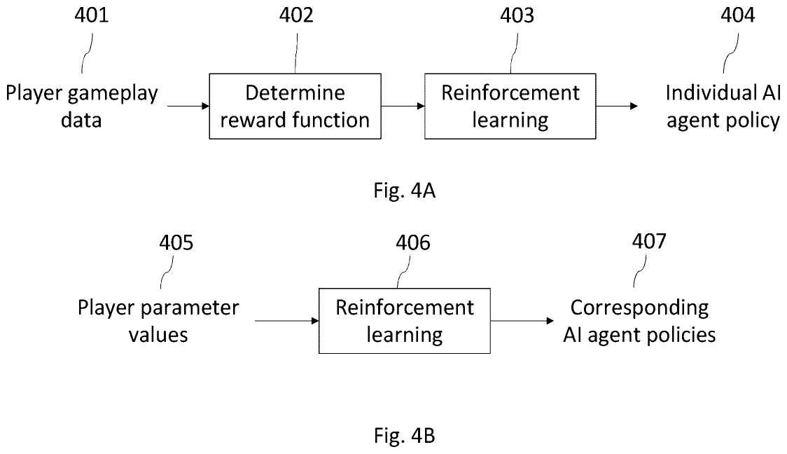

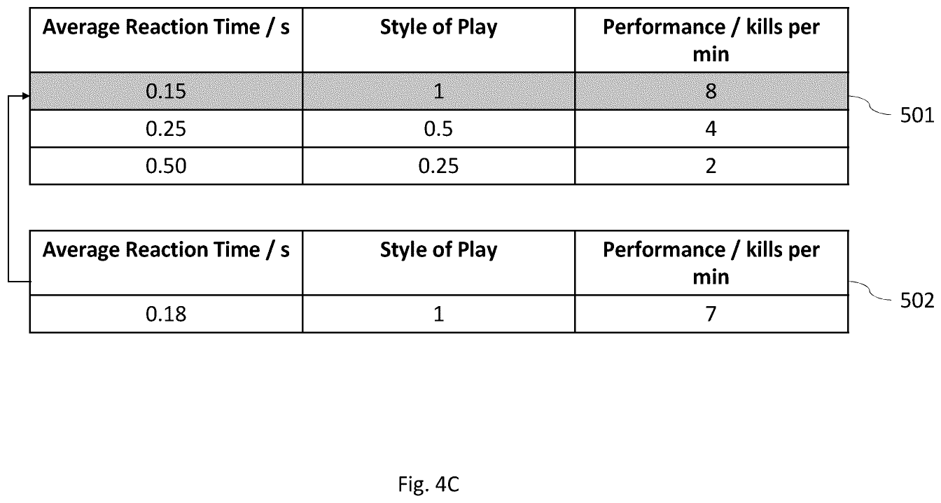

For the first step (configuring the AI agents), a number of training approaches can be used. Two example approaches are shown with reference FIGS. 4A and 4B.

In the first example approach of FIG. 4A, each AI agent is trained using IRL. IRL uses player gameplay data 401 of the corresponding human player (the gameplay data indicating in-game behaviour of a human player, for example, each in-game action taken by a player character under control of the human player, the type of each in-game action taken and the timing of each in-game action) to determine a reward function at step 402. At step 403, RL is then used to generate an AI agent policy 404 which aims to maximise a reward according to the determined reward function. An AI agent policy (which may also be referred to as an AI agent configuration) is a decision process carried out by the AI agent which causes the AI agent to act like a player character controlled by the corresponding human player of that AI agent. Any suitable known RL method may be used (e.g. Q-learning, Deep Q-Learning and/or Deep Convolutional Q-Learning) to determine the AI agent policy 404. Known technique(s) for the implementation of IRL are discussed in [1], for example. According to the first example, the generated AI agent policy is individually determined for the human player from which the player gameplay data is obtained. The AI agent policy thus more closely mimics the human player behaviour and the resulting synthetic gaming ability data and matchmaking are thus more accurate.

In the second example approach of FIG. 4B, rather than using IRL to determine the reward function, a plurality of different reward functions are determined based on respective sets of predetermined values of each of one or more predetermined player parameters (the predetermined player parameters being another example of gameplay data indicating in-game behaviour of a human player). This is exemplified in Table 501 of FIG. 4C, where three player parameters (average reaction time, style of play and performance) and three sets of predetermined values for those player parameters are considered. Only three sets of values for three player parameters are shown in FIG. 4C for simplicity. In reality, there may be a different (e.g. greater) number of sets of values and/or player parameters. The player parameters may also be referred to as gaming parameters.

In the example of FIG. 4C, the video game is a first person shooter (FPS) game (although it will be appreciated the present technology is also applicable to other types of video games).

The average reaction time is, for example, the average time period between an enemy character appearing in a player's field of view and the player performing a predetermined responsive action (such as firing an in-game weapon).

The style of play is, for example, a numerical indicator indicating whether a player more of an active or passive player. An active player is a player who is more likely to initiate attacks on enemy players. A passive player is a player who is more likely to try to remain unseen by other players to avoid attack. In this example, the style of play is indicated by a number from 0 to 1. where 0 is completely passive and 1 is completely active. The number may be determined, for example, by determining the proportion of time in a game that a player controlled character spends out in the open (that is, at locations on the game map without in-game objects usable as cover to defend the character against enemy fire) compared to the amount of time the character spends behind cover. The style of play number reflects the proportion of time in the game during which the user is out in the open.

Thus, looking at Table 501 of FIG. 4C, for example, the player of the first row spends 100% of the game out in the open, the player of the second row spends 50% of the game out in the open (and 50% behind cover) and the player of the third row spends 25% of the game out in the open (and 75% behind cover). The first player is thus a wholly active player (with style of play indicator equal to 1), the second player is equally active and passive (with a style of play indicator equal to 0.5) and the third player is more passive than active (with a style of play indicator equal to 0.25).

The performance indicator is, in this example, the number of kills of enemy characters within a certain time period (in this case, number of kills per minute).

Each set of predetermined values for the predetermined player parameters is used to generate a respective reward function for training a respective AI agent. The reward function of each set corresponds to bringing the player parameter values of the AI agent associated with that set as close as possible to the predetermined parameter values of that set. The AI agent policy which achieves this is retained as the final

AI agent policy. Each set of predetermined values for the predetermined player parameters is thus associated with a different respective AI agent policy.

Once the AI agent for each set of predetermined values of the predetermined player parameters has been trained (and thus the AI agent policy for each AI agent set), one of the AI agents is selected depending on the player parameter values of the human player. In particular, the AI agent with the player parameter values which most closely match those of the human player is selected as the AI agent for that human player. This is exemplified in Table 2 of FIG. 4C, which shows the player parameter values for a given human player. Based on the player parameter values of the human player and the player parameter values of each of the AI agents shown in Table 501, it is determined that the player parameter values in the first row of Table 501 most closely match the player parameter values of the human player. The player parameter values of the human player are determined from one or more previous gaming sessions of the human player, for example.

The determination of which AI agent has player parameter values which most closely match those of the human player can be carried out in any suitable way. For example, the values of each parameter (Average Reaction Time, Style of Play and Performance) may be added together and the resulting sum values compared. The AI agent associated with the lowest sum value difference is then selected as the AI agent. Thus, for example, in this case, the sum value of human player is sₕ=0.18+1+7=8.18. The sum value of the first AI agent of the first row of Table 501 is s₁=0.15+1+8=9.15. The sum value of the second AI agent of the second row of Table 501 is s₂=0.25+0.50+4=4.75. The sum value of the third AI agent of the third row of Table 501 is s₃=0.50+0.25+2=2.75. |sₕ−s₁|=0.97, |sₕ−s₂|=3.43 and |sₕ−s₃|=5.43. Since |sₕ−s₁|=0.97 is the lowest sum value difference, the first agent is selected as the AI agent of the human player. It will be appreciated this is only an example and a different way of comparing the AI agent and human player parameter values may be used. For example, rather than the sum values exemplified here, the root mean square values may be compared.

FIG. 4B shows a generalised example of the second approach. Sets of player parameter values 405 (e.g. those of Table 501) are used to generated respective reward functions for RL (step 406). The output of the RL is a set of AI agent policies 407 (and thus AI agents) respectively corresponding to the sets of player parameter values 405. Again, any suitable known RL method may be used (e.g. Q-learning, Deep Q-Learning and/or Deep Convolutional Q-Learning) to determine each AI agent policy 407 based on its corresponding set of player parameter values 405.

The second example approach thus enables a suitable AI agent likely to have the most similar behaviour to that of a human player to be selected, from a plurality of trained AI agents, for association with that human player. With the second approach, IRL (including determination of the reward function) thus does not have to be performed for each human player individually. This helps save time and processing power and thus allows AI agents for respective human players to be deployed more quickly. This is particularly effective, for example, if there are a large number of players to be matched and for whom AI agent training via IRL has not yet occurred.

Once the AI agents have been trained, the second step (AI agent competition) comprises executing video game sessions in which each trained AI agent competes with each of the other trained AI agents. Each AI agent may compete with each of the other AI agents one or more times. Synthetic gaming ability data (e.g. Elo or MMR score) is generated for each AI agent as a result of the executed gaming sessions. The synthetic gaming ability data is an example of AI agent performance data indicating in-game performance of each AI agent during the AI agent video game session(s).

Since each AI agent, through the training step, has a similar gaming ability to its respective human player, the resulting synthetic gaming ability data generated for each AI agent corresponds with real gaming ability data which would likely have been generated for the human player if they engaged in the same number of gaming sessions. However, since no human player is required for the AI agent gaming sessions, the synthetic gaming ability data can be generated even if the corresponding human player has engaged in only a much smaller number of gaming sessions.

For example, even if a human player has only completed a single gaming session (to enable generation of a reward function to allow AI agent training using IRL and/or to obtain values of the predetermined player parameters to allow AI agent training using RL, for example), a large number of AI agent gaming sessions (e.g. several hundreds or thousands of sessions) for the AI agent corresponding to the human player can be completed to determine the synthetic gaming ability data. Player matchmaking then occurs using the synthetic gaming ability data. Due to the synthetic gaming ability data being generated from a much larger number of gaming sessions than those actually played by the human player, the quality of player matchmaking can be improved.

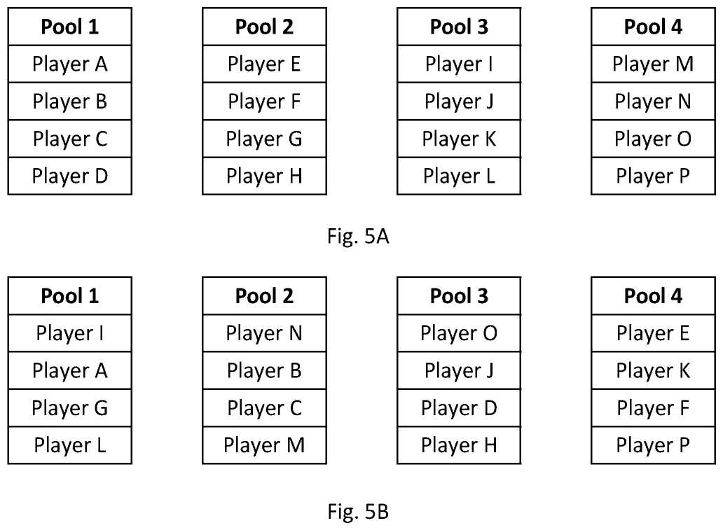

FIGS. 5A and 5B show a simplified example matchmaking technique. Here, a plurality of human players (players identified as Players A-P. in this example, although, in reality, there may be many more players) are arranged into a plurality of pools (pools identified as Pools 1-4, in this example, although, in reality, there may be many more pools).

Initially, before synthetic gaming ability data has been determined for each of the human players, the human players are randomly distributed among the pools. Thus, Pool 1 contains Players A-D, Pool 2 contains Players E-H, Pool 3 contains Players I-L and Pool 4 contains Players M-P. This is shown in FIG. 5A.

The AI agents associated with the players then compete against each other in video game sessions in the way described. Each video game session involving AI agents is executed on the server(s) 300, for example. This allows synthetic gaming ability data for each AI agent (and thus, each corresponding human player) to be generated. As described, due to the training of the AI agents, the synthetic gaming ability data of each AI agent reflects the gaming ability of the human player associated with that agent. Based on the generated synthetic gaming ability data, players with a similar ability are allocated to the same pool. Matchmaking (for gaming sessions between human players rather than AI agents) then occurs between players within the same pool.

In an example, all players are ranked based on their respective synthetic gaming ability data. A predetermined number of the highest ranked players is then assigned to a first pool. The same predetermined number of the next highest ranked players is then assigned to the next pool, and so on. This is exemplified in FIG. 5B, which shows the highest ranked Players I, A, G and L assigned to Pool 1, the next highest ranked Players N, B, C and M assigned to Pool 2, the next highest ranked Players O. J. D and H assigned to Pool 3 and the next highest ranked Players E, K. F and P assigned to Pool 4. During an online gaming session, for example, Player I will thus be matched with Player A, G or L whereas Player E will be matched with Player K, F or P. Due to the use of synthetic gaming ability data obtained via the AI agent gaming sessions, the likelihood of these matches being appropriate is improved, even if the amount of gameplay by each human player is small.

The example of FIGS. 5A and 5B is only an example and it will be appreciated that any known matchmaking algorithm which currently uses real gaming ability data of players may be used instead with synthetic gaming ability data of the same data type.

In an example, real gaming ability data (e.g. a real Elo or MMR score) may be used with synthetic gaming ability data for use in matchmaking (e.g. for use in determining which pool a particular player should belong to in FIG. 5B). That is, a combination of previous in-game performance of the human player (e.g. the real current Elo or MMR score of the human player from previous gaming sessions) and in-game performance of the corresponding AI agent during the one or more AI agent gaming sessions may be used for matchmaking.

For example, a player's current real Elo or MMR score may be provided as an initial value. Based on the results of subsequent gaming sessions executed with the player's trained AI agent, this initial value is then adjusted to generate an updated value reflecting the AI agent's performance.

In another example, the average of a real Elo/MMR score and a synthetic Elo/MMR score may be used to generated a combined score to rank a particular player. The average may be a weighted average. For example, it may be weighted depending on the amount of gameplay of the human user and the amount of gameplay of the associated AI agent (the amount of gameplay being the total duration of gameplay of the video game concerned, for instance).

For instance, if the total duration of both the human and AI agent gameplay for a particular game is the same, the weightings of the real and synthetic Elo/MMR scores may be the same. On the other hand, if the total duration of the AI agent gameplay is five times greater than that of the human gameplay, the weightings of the real and synthetic Elo/MMR scores may be in the ratio 1:5. This helps provide an appropriate contribution to the combined Elo/MMR score of each of the human player and their associated AI agent depending on the amount of human and AI gameplay, thereby helping improve the accuracy of the combined Elo/MMR score as the amount of time a human player dedicates to a particular game changes over time. For instance, it means the synthetic Elo/MMR score is relied on more if a player has not spent a lot of time playing a particular video game. However, if the player then starts to play that video game more often and for longer, the real Elo/MMR score associated with such gaming sessions makes a bigger contributed to the weighted average.

The present technology therefore enables matchmaking for multiplayer gaming sessions between human players (e.g. based on the generated pools of FIG. 5B) based on the results of gaming sessions executed between AI agents trained to behave like those human players. This helps provide improved matchmaking, especially when data regarding the performance of a particular human player is limited.

Furthermore, since the AI agent gaming sessions for generating the synthetic gaming ability data are not intended to be watched by a human (rather, only the outcome of each AI agent gaming session in terms of the synthetic gaming ability data generated for each AI agent needs to be known), the AI agent gaming sessions are less bound by the requirements of believability. Elements of the gaming experience associated with believability therefore do not need to be present, thereby providing opportunities for increased speed (allowing gaming sessions to be completed more quickly and thus allowing more gaming sessions to be completed within a given period of time) and/or reduced computational complexity in running the simulations.

For example, gaming sessions may be run at lower resolution and/or level of detail (LOD) and/or with a higher frame rate. Furthermore, the processing requirement associated with ensuring smoothness of movement and/or camera control can be alleviated. For instance, a camera view requiring the least intensive graphics rendering (e.g. a bird's eye view rather than point-of-view camera) may be used throughout each gaming session and frames required for ensuring a smooth perception of motion for a human player may be skipped (thereby reducing the number of frames that must be rendered overall). Thus, for example, only every nth frame may be rendered (where n=2, 5 or 10, for example).

This allows, for instance, the rate at which gaming sessions can be completed to be increased and/or the amount of processing to be reduced. For instance, if n=5, this means only the 1^{st}, 6^{th}, 11^{th}, etc. frames are rendered. Furthermore, if the rendered frame rate is increased from 120 Hz. to 240 Hz (with, for example, half the resolution and/or LOD per frame, so the processing load is not increased), this means 10 seconds of AI agent gameplay can be rendered using the same amount of processing as required for 1 second of human player gameplay. This allows AI agent gaming sessions to be executed more quickly and/or with reduced processing compared to human player gaming sessions, thereby allowing synthetic gaming ability data and the resulting improvement in player matchmaking to be quickly and efficiently obtained.

The present technology thus helps provide improved matchmaking in multiplayer games while requiring less real life player performance data (which takes a long time to obtain and may not be available for some players). This helps provide an improved multiplayer gaming experience.

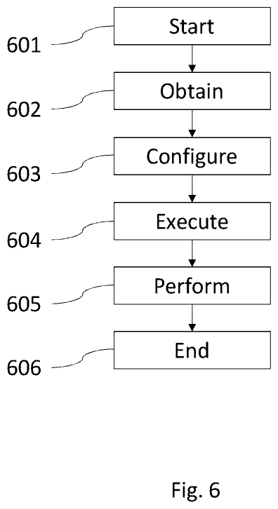

FIG. 6 shows an example method. The method is executed by the CPU 20 and/or GPU 30 of one of more games consoles 110 and/or the processor 302 of one or more servers 300, for example.

The method starts at step 601.

At step 602, gameplay data indicating in-game behaviour of a human video game player is obtained. For example, if the method is executed by the server 300, gameplay data from one of games consoles 110A, 110B or 110C is received by server 300.

At step 603, using the obtained gameplay data, an artificial intelligence, AI, agent representing the human video game player is configured (e.g. using one of the training processes exemplified above).

At step 604, one or more AI agent video game sessions including the AI agent are executed and AI agent performance data indicating in-game performance of the AI agent during the one or more AI agent video game sessions is obtained.

At step 605, matchmaking of the human video game player with another human video game player is performed based on the obtained AI agent performance data. The matchmaking comprises controlling the respective games consoles of the human video game player and other human video game player to exchange data (e.g. via server 300) to engage in multiplayer gaming with each other.

The method ends at step 606.

Example(s) of the present technique are defined by the following numbered clauses:
1. A data processing apparatus comprising circuitry configured to:
   obtain gameplay data indicating in-game behaviour of a human video game player;
   configure, using the obtained gameplay data, an artificial intelligence, AI, agent representing the human video game player;
   execute one or more AI agent video game sessions including the AI agent and obtain AI agent performance data indicating in-game performance of the AI agent during the one or more AI agent video game sessions; and
   perform matchmaking of the human video game player with another human video game player based on the obtained AI agent performance data.
2. A data processing apparatus according to clause 1, wherein the AI agent is configured using inverse reinforcement learning.
3. A data processing apparatus according to clause 1, wherein the AI agent is configured using reinforcement learning.
4. A data processing apparatus according to clause 3, wherein:
   the obtained gameplay data comprises a value of each of one or more gaming parameters; and the circuitry is configured to:
   select a configuration of the AI agent from a plurality of predetermined AI agent configurations based on the value of each of the one or more gaming parameters and predetermined values of each of the one or more gaming parameters associated with the predetermined AI agent configurations, the predetermined values of each of the one or more gaming parameters associated with the predetermined AI agent configurations being used to determine the predetermined AI agent configurations using the reinforcement learning.
5. A data processing apparatus according to clause 4, wherein the one or more gaming parameters comprise one or more of average reaction time, style of play and performance.
6. A data processing apparatus according to any preceding clause, wherein the obtained AI agent performance data comprises a numerical performance score indicative of gaming performance of the AI agent.
7. A data processing apparatus according to clause 6, wherein the numerical performance score is generated based on a combination of previous in-game performance of the human video game player and in-game performance of the AI agent during the one or more AI agent video game sessions.
8. A data processing apparatus according to clause 7, wherein:
   a human player numerical performance score indicative of the previous in-game performance of the human video game player is used as an initial value of the numerical performance score; and
   the initial value of the numerical performance score is adjusted based on the in-game performance of the AI agent during the one or more AI agent video game sessions to generate an updated value of the numerical performance score.
9. A data processing apparatus according to clause 7, wherein the numerical performance score is an average of a human player numerical performance score indicative of the previous in-game performance of the human video game player and an AI agent numerical performance score indicative of the in-game performance of the AI agent during the one or more AI agent video game sessions.
10. A data processing apparatus according to clause 9, wherein the average is a weighted average weighted according to an amount of gameplay of each of the human video game player and AI agent.
11. A data processing apparatus according to any one of clauses 6 to 10, wherein the numerical performance score is an Elo or Matchmaking Rating, MMR, score.
12. A data processing apparatus according to any preceding clause, wherein the one or more AI agent video game sessions are executed with one or more of a reduced resolution, reduced level of detail, increased frame rate and reduced frame number.
13. A computer-implemented data processing method comprising:
   obtaining gameplay data indicating in-game behaviour of a human video game player;
   configuring, using the obtained gameplay data, an artificial intelligence, AI, agent representing the human video game player;
   executing one or more AI agent video game sessions including the AI agent and obtain AI agent performance data indicating in-game performance of the AI agent during the one or more AI agent video game sessions; and
   performing matchmaking of the human video game player with another human video game player based on the obtained AI agent performance data.
14. A program for controlling a computer to perform a method according to clause 13.
15. A computer-readable storage medium storing a program according to clause 14.

Numerous modifications and variations of the present disclosure are possible in light of the above teachings. It is therefore to be understood that, within the scope of the claims, the disclosure may be practiced otherwise than as specifically described herein.

In so far as embodiments of the disclosure have been described as being implemented, at least in part, by one or more software-controlled information processing apparatuses, it will be appreciated that a machine-readable medium (in particular, a non-transitory machine-readable medium) carrying such software, such as an optical disk, a magnetic disk, semiconductor memory or the like, is also considered to represent an embodiment of the present disclosure. In particular, the present disclosure should be understood to include a non-transitory storage medium comprising code components which cause a computer to perform any of the disclosed method(s).

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more computer processors (e.g. data processors and/or digital signal processors). The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to these embodiments. Additionally, although a feature may appear to be described in connection with particular embodiments, one skilled in the art would recognize that various features of the described embodiments may be combined in any manner suitable to implement the present disclosure.

What is claimed is:

1. A data processing apparatus comprising circuitry configured to:
obtain gameplay data indicating in-game behaviour of a human video game player;
configure, using the obtained gameplay data, an artificial intelligence, AI, agent representing the human video game player;
execute one or more AI agent video game sessions including the AI agent and obtain AI agent performance data indicating in-game performance of the AI agent during the one or more AI agent video game sessions; and
perform matchmaking of the human video game player with another human video game player based on the obtained AI agent performance data.

2. A data processing apparatus according to claim 1, wherein the AI agent is configured using inverse reinforcement learning.

3. A data processing apparatus according to claim 1, wherein the AI agent is configured using reinforcement learning.

4. A data processing apparatus according to claim 3, wherein:
the obtained gameplay data comprises a value of each of one or more gaming parameters; and the circuitry is configured to:
select a configuration of the AI agent from a plurality of predetermined AI agent configurations based on the value of each of the one or more gaming parameters and predetermined values of each of the one or more gaming parameters associated with the predetermined AI agent configurations, the predetermined values of each of the one or more gaming parameters associated with the predetermined AI agent configurations being used to determine the predetermined AI agent configurations using the reinforcement learning.

5. A data processing apparatus according to claim 4, wherein the one or more gaming parameters comprise one or more of average reaction time, style of play and performance.

6. A data processing apparatus according to claim 1, wherein the obtained AI agent performance data comprises a numerical performance score indicative of gaming performance of the AI agent.

7. A data processing apparatus according to claim 6, wherein the numerical performance score is generated based on a combination of previous in-game performance of the human video game player and in-game performance of the AI agent during the one or more AI agent video game sessions.

8. A data processing apparatus according to claim 7, wherein:
a human player numerical performance score indicative of the previous in-game performance of the human video game player is used as an initial value of the numerical performance score; and
the initial value of the numerical performance score is adjusted based on the in-game performance of the AI agent during the one or more AI agent video game sessions to generate an updated value of the numerical performance score.

9. A data processing apparatus according to claim 7, wherein the numerical performance score is an average of a human player numerical performance score indicative of the previous in-game performance of the human video game player and an AI agent numerical performance score indicative of the in-game performance of the AI agent during the one or more AI agent video game sessions.

10. A data processing apparatus according to claim 9, wherein the average is a weighted average weighted according to an amount of gameplay of each of the human video game player and AI agent.

11. A data processing apparatus according to claim 6, wherein the numerical performance score is an Elo or Matchmaking Rating, MMR, score.

12. A data processing apparatus according to claim 1, wherein the one or more AI agent video game sessions are executed with one or more of a reduced resolution, reduced level of detail, increased frame rate and reduced frame number.

13. A computer-implemented data processing method comprising:
obtaining gameplay data indicating in-game behaviour of a human video game player;
configuring, using the obtained gameplay data, an artificial intelligence, AI, agent representing the human video game player;
executing one or more AI agent video game sessions including the AI agent and obtain AI agent performance data indicating in-game performance of the AI agent during the one or more AI agent video game sessions; and
performing matchmaking of the human video game player with another human video game player based on the obtained AI agent performance data.

14. A non-transitory computer-readable storage medium storing a program for controlling a computer to perform a method comprising:
obtaining gameplay data indicating in-game behaviour of a human video game player;
configuring, using the obtained gameplay data, an artificial intelligence, AI, agent representing the human video game player;
executing one or more AI agent video game sessions including the AI agent and obtain AI agent performance data indicating in-game performance of the AI agent during the one or more AI agent video game sessions; and
performing matchmaking of the human video game player with another human video game player based on the obtained AI agent performance data.
